(19) United States
(12) Patent Application Publication
(10) Pub. No.: US 2018/0348541 A1
(43) Pub. Date: Dec. 6, 2018

(54) POP-UP TYPE HOLDER AND STAND MOBILE DEVICE ACCESSORY FOR HOLDING EYEGLASSES

(71) Applicant: Eric Radzwill, Oakland Park, FL (US)

(72) Inventor: Eric Radzwill, Oakland Park, FL (US)

(21) Appl. No.: 15/994,710

(22) Filed: May 31, 2018

Related U.S. Application Data
(60) Provisional application No. 62/603,441, filed on May 31, 2017.

(51) Int. Cl. G02C 3/04; H04B 1/3888; A45F 5/10; G02C 5/00

(52) U.S. Cl. CPC G02C 3/04; H04B 1/3888; H04M 1/04; G02C 5/006; A45F 5/10

(57) ABSTRACT

A pop-up type holder and stand mobile phone accessory includes a base, a collapsible member, and a foot. The collapsible member is connected to the base at a first end, and to the foot at a second end. The base is configured to be attached or mounted to the back of a mobile device, or to the case of a mobile device, and the foot can be extended be expanding the collapsible member for use, to facilitate holding the mobile device by a user, or retained against the base by collapsing the collapsible member. The base or the foot includes a pocket that is configured to hold and retain a pair of folding nose clip-on type eyeglasses.

### CROSS-REFERENCE TO RELATED APPLICATION

This application claims priority to U.S. Provisional Patent Application No. 62/603,441 filed May 31, 2017, the entirety of which is incorporated by reference.

### FIELD OF THE INVENTION

The present invention relates generally to accessories for cellular phones and similar mobile devices, and more particularly to an expanding stand/holder that includes a pocket for holding collapsible glasses.

### BACKGROUND OF THE INVENTION

Cellular phones and other handheld mobile devices are in widespread use, to the point that many people carry such a device everywhere they go. These devices have become much more than merely a wireless telephone. As these devices have evolved over time their form factor has changed, based on how people have used them in the past. Presently, the most common form factor is a tablet format, with the device being generally rectangular with the majority of the front surface being dedicated to a graphical display, with buttons and connector being on the sides. This format is generally preferred as it makes presentation of information on the display easier to read and interact with, which is the kind of activity that these devices have come to be predominantly used.

The rectangular, tablet form factor, while useful for presenting information, doesn't lend itself well to being held for interacting with the device, i.e. using fingers to enter information, select items, etc. As a result, there have been a number of accessories developed to assist a user in holding their mobile device. One of the more popular accessories is a “pop up” stand/holder that includes a base that adheres to the back of the device or a case in which the device is held, and has a top portion that can extend away from the base by a collapsible structure between the top and base portions. When not in use the structure can be collapsed with the that the top portion is against the case, minimizing its profile for carrying in a pocket, hand, purse, etc. To hold the device, the structure can be extended to slide between a user's fingers to facilitate holding the device, or to support the device on a surface as a stand.

The increasingly common use of mobile devices also presents a challenge to people who are older, and may have some difficulty reading or viewing information on the relatively small area of the display. It is quite common for people, as they mature, to have a need for reading glasses, including for reading or viewing their mobile device, comfortably. Several accessories have been developed to hold regular reading glasses in conjunction with holding a mobile phone device, but these do lend themselves to holding the mobile phone device, and add to the awkward bulk of the mobile phone device

Accordingly, there exists a need to overcome the problems associated with the prior art as discussed above.

### SUMMARY OF THE INVENTION

The invention provides a pop-up type holder and stand mobile device accessory that overcomes the hereinafore-mentioned disadvantages of the heretofore-known devices and methods of this general type and that further includes a pocket formed in one or both of the foot and base of the accessory that is configured to hold a pair of folding nose clip-on type eyeglasses. With the foregoing and other objects in view, there is provided, in accordance with the invention, a collapsible holder and stand accessory for a mobile device that includes a base which is adapted to be coupled to a case of the mobile device, and a foot. The accessory further includes a collapsible member joining the base to the foot that is moveable between a collapsed state and an extended state along a direction of movement. The foot defines a plane that is perpendicular to the direction of movement of the collapsible member, and includes a pocket formed inside the foot and open and a slot on an edge of the foot.

In accordance with another feature, the base can include a layer of adhesive on a bottom side of the base.

In accordance with another feature, the base can be the base of the collapsible member.

In accordance with another feature, the collapsible member can include a spring which urges the foot away from the base.

In accordance with another feature, the collapsible member can be a hollow member having an accordion wall configured to allow the collapsible member to collapse and expand.

In accordance with another feature, the accordion wall can be conically shaped.

In accordance with another feature, the base and foot can have corresponding and complementary retaining features configured to retain the foot with the collapsible member in the collapsed state.

In accordance with another feature, the foot can include an indented portion at the slot.

In accordance with another feature, the slot can have a slot width which is less than a maximum pocket width.

In accordance with another feature, an embodiment of the present invention includes a collapsible holder and stand accessory for a mobile device that includes a base which is adapted to be coupled to a case of the mobile device. The accessory can further include a collapsible member joined to the base at a first end of the collapsible member. The collapsible member is moveable between a collapsed state and an extended state along a direction of movement. The accessory can further include a foot coupled to the collapsible member at a second end of the collapsible member that is opposite the first end, wherein the foot includes a top and a corresponding bottom defining a pocket between the top and bottom, wherein a portion of the foot is indented from an edge of the foot, and a sidewall is disposed around an outside of the foot between the top and the bottom except for the indented portion, thereby defining a slot opening into the foot at the portion of the foot that is indented.

In accordance with another feature, an embodiment of the present invention includes a collapsible holder and stand and eyeglass holder accessory for a mobile device, that includes a base defining a plane and configured to be attached at a bottom of the base to the mobile device or a case of the mobile device, a pocket formed in the base that is accessible by a slot opening in a side of the base and which is configured to hold and retain folded eyeglasses. The accessory can further include a collapsible member joined to the base at a first end of the collapsible member. The collapsible member is moveable between a collapsed state and an extended state along a direction of movement the is perpendicular to the plane defined by the base. The accessory can further include a foot attached to the collapsible member at a second end of the collapsible member.

In accordance with some embodiments, the holder and stand accessory can include a base that is configured to be attached to, or mounted on the back of a mobile device. The base includes a pocket, accessible by a slot, for holding and retaining a pair of nose clip-on eyeglasses, in a folded or unfolded state. The structure is provided on top of the base that can be extended to act as a hold or as a stand to prop-up the mobile device for viewing by the user. The structure can include a hinged ring, leg or similar structure that is coupled at one end/side to the base, and the opposite end/side is able to move away from, and towards the base about the hinged end/side. A detent can be provided to hold the folding structure in the extended position, when in use, or in the collapsed position against the base when not in use.

Although the invention is illustrated and described herein as embodied in a pop-up type holder and stand accessory including a pocket for eyeglasses, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the movement of the collapsible member. Those skilled in the art can understand the specific meanings of the above-mentioned terms in the embodiments of the present invention according to the specific circumstances

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 shows an isometric view of a holder and stand accessory having a pocket for holding eyeglasses, in accordance with some embodiments;

FIG. 2 shows a side elevational view of a holder and stand accessory having a pocket for holding eyeglasses, in accordance with some embodiments;

FIG. 3 shows a side cut-away view of a holder and stand accessory having a pocket for holding eyeglasses, in accordance with some embodiments;

FIG. 4 shows a use diagram illustrating how eyeglasses are kept in a holder and stand accessory, in accordance with some embodiments;

FIG. 5 shows a use diagram illustrating how eyeglasses are kept in a holder and stand accessory, in accordance with some embodiments;

FIG. 6 shows a side elevational view of a holder and stand accessory having a pocket for storing eyeglasses, in accordance with some embodiments;

FIG. 7 shows a side portion diagram of a base and a foot of a holder and stand accessory and retaining features for retaining the accessory in a collapsed state, in accordance with some embodiments;

FIG. 8 shows a side elevational view of a holder and stand accessory having an eyeglass pocket in the base of the accessory, in accordance with some embodiments;

FIG. 9A shows a perspective view, generally from the bottom, of an exemplary holder and stand accessory including a pocket for holding folded eyeglasses, in an extended state, in accordance with some embodiments;

FIG. 9B shows a perspective view, generally from the bottom, of an exemplary holder and stand accessory including a pocket for holding folded eyeglasses, in a closed state, in accordance with some embodiments;

FIG. 9C shows a perspective cut-away view, generally from the top, of an exemplary holder and stand accessory including a pocket for holding folded eyeglasses, in a closed state, in accordance with some embodiments;

FIG. 9D shows a perspective cut-away view, generally from the top, of an exemplary holder and stand accessory including a pocket for holding folded eyeglasses, in an expanded state, in accordance with some embodiments;

FIG. 9E shows a perspective view, generally from the top, of an exemplary holder and stand accessory including a pocket for holding folded eyeglasses, in a closed state, with the eyeglasses out of the pocket, in accordance with some embodiments; and

FIG. 10 shows a side elevational cut-away view of a holder and stand accessory including one or more magnets, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient mobile device accessory in the form of a “pop up” collapsible holder and stand that attaches to the back of the mobile device, and includes a pocket that is configured to hold and retain a pair of folding nose clip-on type eyeglasses. Embodiments of the invention provide an accessory having a base configured to attach to the back of a mobile device or the case of a mobile device. A collapsible member is attached to the base at a first end of the collapsible member, and to a foot at a second end of the collapsible member, allowing the foot to be extended for use or retained against the base when not in use. The eyeglass pocket is formed in the foot, or the base, or both (for different prescriptions).

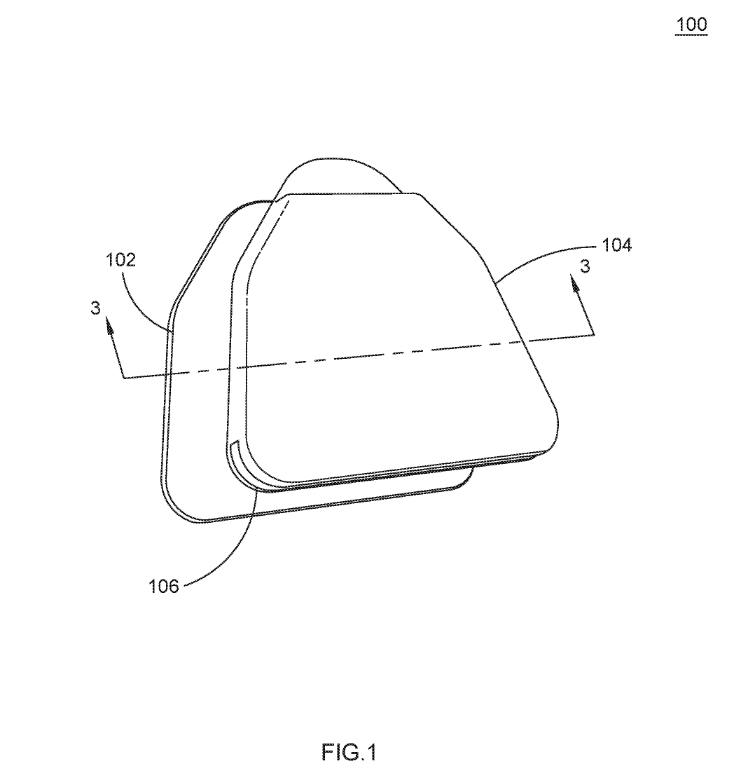

FIG. 1 shows an isometric view of a holder and stand accessory 100 having a pocket for holding eyeglasses, in accordance with some embodiments. Specifically, the holder and stand accessory 100 is a “pop-up” type of accessory that is configured to be mounted or attached on the back of a mobile device that can be collapsed when not in use, and expanded to facilitate holding the mobile device, or to use as a stand to orient the mobile device in a position other than lying on its back on a surface so that a person can look more directly at the front of the mobile device. Such pop-up accessories are common, but provide no other function. The holder and stand accessory includes a base 102 and a foot 104 that can move vertically relative to each other. That is, the base 102 and foot 104 are each generally planar elements and each define planes that are parallel to each other, and the base 102 and foot 104 can move in a direction perpendicular to those defined planes. The base 102 is configured to be mounted or attached to the back of a mobile device (i.e. the side opposite the graphical display). The base 102 can be attached by an adhesive layer of material, or by interfacing with a mechanical retention feature (e.g. a mount). The foot 104, when extended, can rest against a surface on which the mobile device is resting to hold the mobile device so that the user can more easily see the display of the mobile device, or the foot 104 can act as a hold against which the user's fingers bear while holding and interacting with the mobile device. The base 102 and the foot 104 are joined together by a collapsible member (not seen in this view) that supports the foot 104, when extended, in some embodiments. In some embodiments the base can simply be the bottom of the collapsible member.

Within the foot 104 is a pocket, formed by a hollow space between the top and bottom of the foot 104. The pocket is accessible by a slot 106 on the side of the foot 104. The pocket is sized to hold a pair of eyeglasses that are a folding, clip on type of eyeglasses. The eyeglasses can sit in, and be retained in the pocket with a portion extending out the other side 108 from the slot 106.

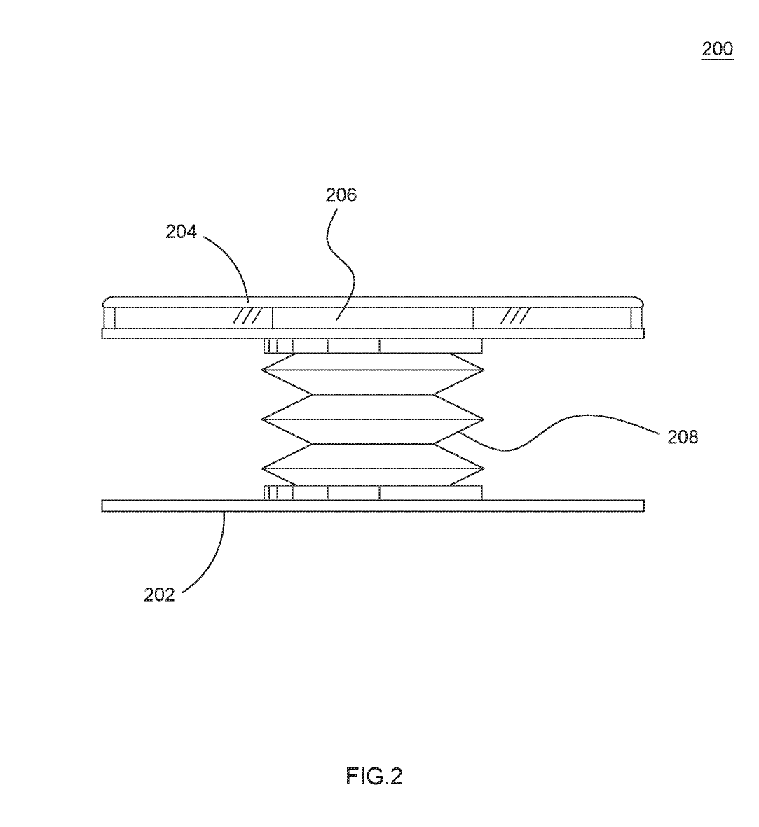

FIG. 2 shows a side elevational view of a holder and stand accessory 200 having a pocket 206 for holding eyeglasses, in accordance with some embodiments. The accessory 200 shown here can be substantially similar to that shown in FIG. 1. The accessory 200 includes a base 202 and a foot 204 which are coupled together by a collapsible member 208. As shown here, the collapsible member 208 is formed using an accordion configuration that allows portions of the collapsible member to fold over each other when collapsed. Furthermore, the collapsible member 208 is formed in a generally cylindrical form factor, where the segments all have the same width. The collapsible member 208 allows the foot 204 to move relative to the base 202. As shown here, the base 202 and foot 204 define planes that are parallel, and perpendicular to the direction of movement of the collapsible member. The collapsible member 208 can be formed such that the segment defined by the folds of the collapsible member, when embodied in an accordion format as shown here, the segments can be configured such that when compressed and closed, the segments are self-biased to remain collapsed. Likewise, the segments of the collapsible member 208 can be configured to be biased to remain open when the foot is moved away from the base. A slot opens into the interior space forming a pocket 210 between the top and bottom of the foot, the top being the uppermost wall in this view, and the bottom being the lowermost wall to which one end of the collapsible member 208 is attached or coupled. Another slot 206 can be seen through the slot and the pocket 210. The eyeglasses can be placed into the pocket and retained therein until a user retrieves them from the pocket 210 for use.

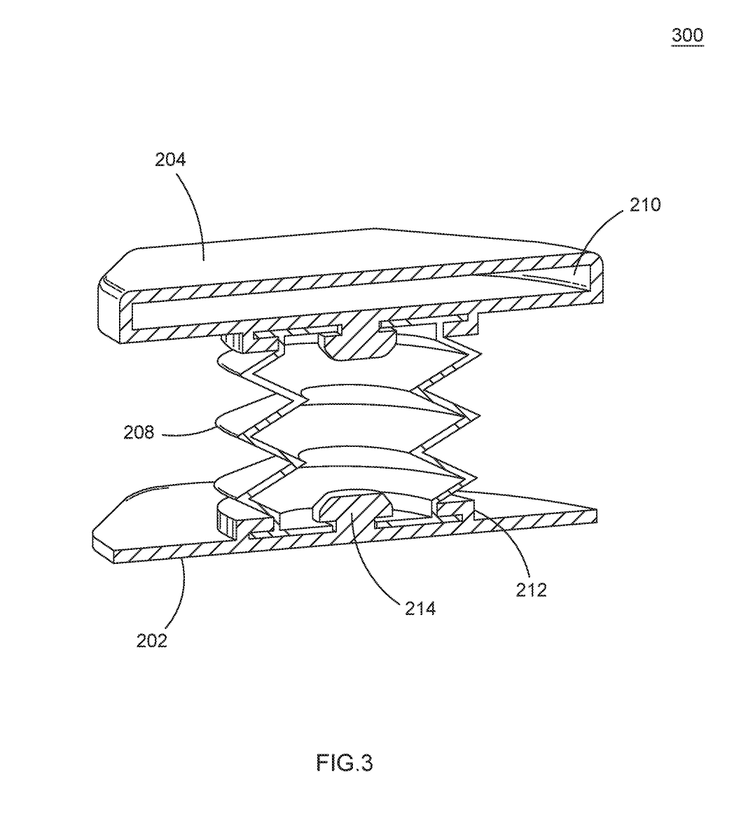

FIG. 3 shows a side cut-away view of a holder and stand accessory 200 having a pocket for holding eyeglasses, in accordance with some embodiments. This view shows an example of the accessory 200 of FIG. 2 cut-away to show the collapsible member 208 is hollow and attached at a first end to the base 204 and at a second end to the bottom of the foot 204. In some embodiments the collapsible member 208 can be attached with retaining features such as a ledge 212 and a flared post 214 that interfere with a end wall of the collapsible member 208.

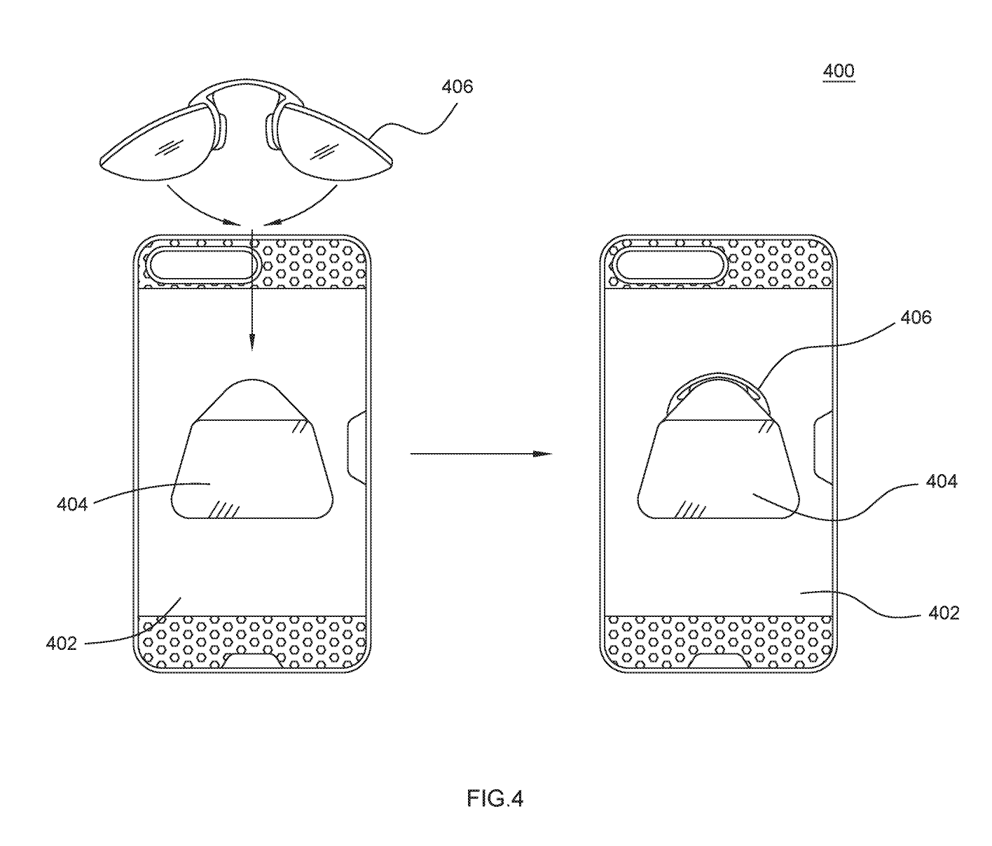

FIG. 4 shows a use diagram 400 illustrating how eyeglasses are kept in a holder and stand accessory, in accordance with some embodiments. On the left, the eyeglasses 406 are outside of the pocket of the holder and stand accessory 404 that is mounted on the back of a mobile device 402. The holder and stand accessory 404 can be substantially similar to that of FIGS. 1-3. The eyeglasses 406 have a flexible bridge between the lenses and no temple/ear portions. Rather, the eyeglasses bend to allow the user to clip them onto the bridge of the user's nose, and the spring action of the flexible bridge produces a resulting inward force as a result of being spread apart by the bridge of the user's nose. As a result, the static friction created by the force holds the eyeglasses on the user's nose. When not in use, the lens portions of the eyeglasses can be folded in toward each other, in the plane defined by the lenses, bending the bridge, and the folded eyeglasses can then be inserted into the pocket in the foot of the holder and stand accessory, and shown on the right side of the diagram. The spring action of the bridge of the eyeglasses 406 can urge the lenses outward, against the sides of the pocket, which are the sides of the foot. The resulting force against the inside of the pocket can act to retain the eyeglasses 406 in the pocket. Thus, the pocket in the foot can be shaped, in consideration of the shape of the folded eyeglasses 406, to provide retention of the folded eyeglasses 406.

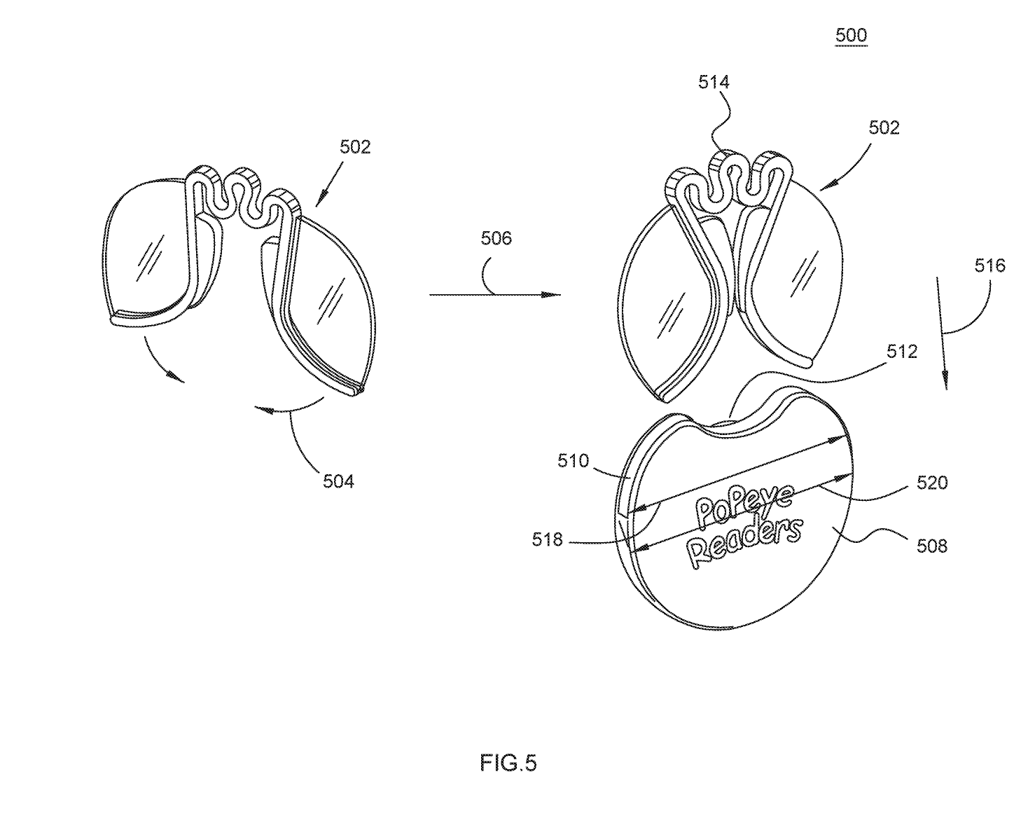

FIG. 5 shows a use diagram 500 illustrating how eyeglasses are kept in a holder and stand accessory, in accordance with some embodiments. In this view a different form factor of the eyeglasses 502 and the foot 508 are shown. The eyeglasses 502 can be folded by moving the lenses in the direction of arrow 504. Once folded, the folded eyeglasses can be moved (506) to place them into the pocket in the foot 508, though a slot 510, in the direction of arrow 516. In embodiments consistent with those of FIG. 5, the foot 508 can be substantially circular in the plane defined by the major surface of the foot 508. The slot 510 can have a slot width 518 that is less than a maximum pocket width 520, which creates a retaining structure for the folded eyeglasses 502 to retain them in the pocket. The bridge 514 of the eyeglasses 502 acts as a spring, urging the lenses outward against the sidewalls of the pocket/sidewall. An indented portion 512 of the foot 508 can allow a user to grasp the bridge 514 when the folded eyeglasses 502 are in the pocket, to remove the eyeglasses 502 from the pocket. The foot 508 is attached to a base by a collapsible member such as in FIGS. 1-3, and the base can be attached to or otherwise mounted on a mobile device or a case of a mobile device.

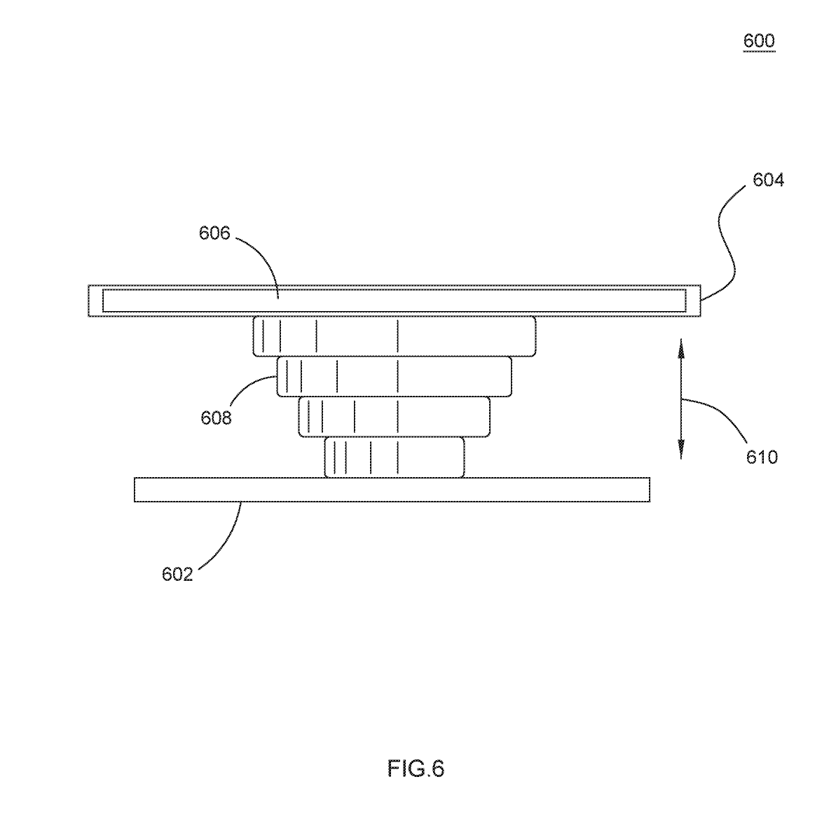

FIG. 6 shows a side elevational view of a holder and stand accessory 600 having a pocket 606 for storing eyeglasses, in accordance with some embodiments. A base 602 is configured to be attached or mounted to a mobile device. A collapsible member 608 is coupled to the base at a first end of the collapsible member 608, and is further coupled to a foot 604 at a second end of the collapsible member. In embodiments consistent with those represented by FIG. 6, the collapsible member 608 is conically shaped. As shown here the collapsible member 608 is extended, and when the collapsible member 608 is collapsed, when the foot 604 is moved in the direction of arrow 610, the segments of the collapsible member 608 collapse concentrically around each other.

Thus, there are a variety of collapsible member configurations that can be used equivalently. In some embodiments the collapsible members can have an accordion configuration, including accordion configurations that retain their shape when extended or collapsed. In some embodiments the collapsible member can be conically shaped, using a similar accordion operation, to collapse the segments concentrically. In some embodiments a coil spring can be used as the collapsible member, or to urge the foot away from the base.

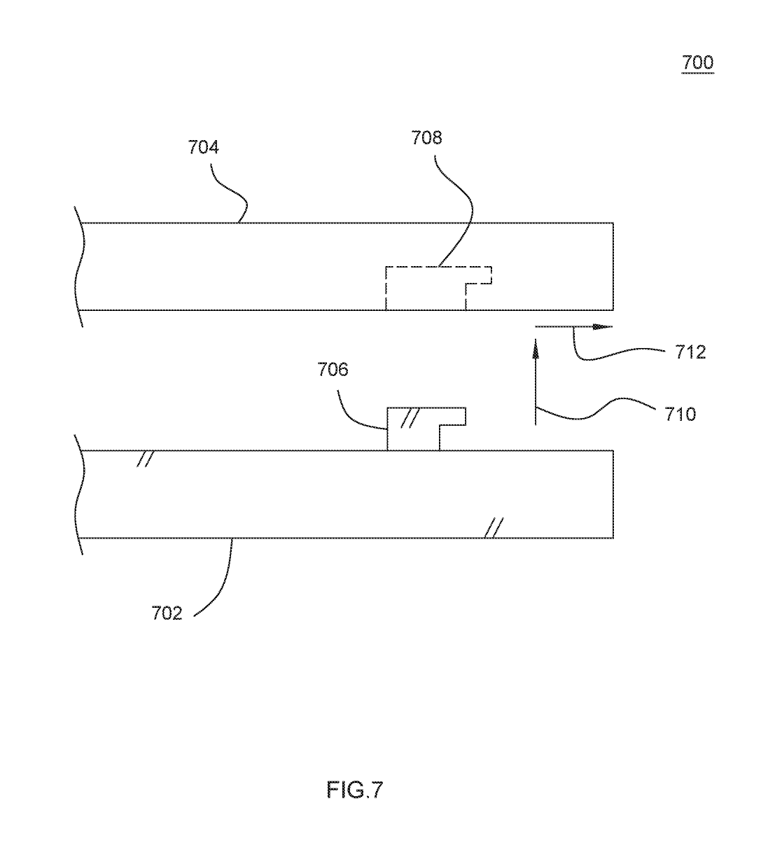

FIG. 7 shows a side portion diagram 700 of a base 702 and a foot 704 of a holder and stand accessory and retaining features for retaining the accessory in a collapsed state, in accordance with some embodiments. Specifically a side wall of the base is shown that can extend upward from the main portion of the base 702, and can include a finger 706. In some embodiments a spring may be used to urge the foot 704 away from the base 702 to an extended state or position, and the user must push in the base 704 to compress the spring. The base can have a corresponding retaining ledge structure 708 to engage the finger 706 upon the user causing finger 706 to enter the ledge structure 708, as indicated by arrow 710, and the rotating the foot 704 as indicated by arrow 712 to engage the finger 706 in the ledge 708, retaining the foot 704 to the base 702. A variety of different retaining features similar to that shown here can be realized equivalently.

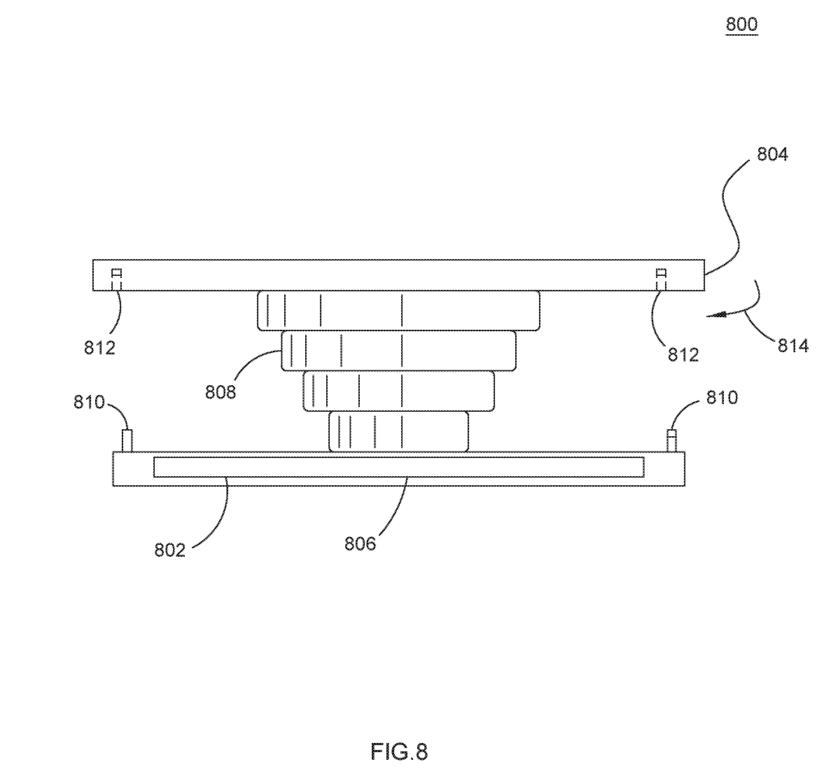

FIG. 8 shows a side elevational view of a holder and stand accessory 800 having an eyeglass pocket 806 in the base 802 of the accessory, in accordance with some embodiments. The base 802 is configured to be attached to a mobile device, such as by adhesive or a mechanical mount, and includes a pocket 806 accessible by a slot opening in which folded eyeglasses can be inserted for retention and keeping until the user removes them for use. In this respect the pocket 806 an be substantially similar to that shown and described in reference to FIGS. 1-6. A collapsible member 808 is attached to the top of the base 802 at a first end of the collapsible member, and to a foot 804 at a second end of the collapsible member. The collapsible member 808 shown here is a conical, concentrically collapsing member, but any collapsible member suitable for the function described herein can be used, as is the case with the embodiments represented in FIGS. 1-6. The base can include finger structures 810 that mate with corresponding ledge structure 812 for retaining the foot 804 when the accessory is in a collapsed state. To engage the fingers 810 into the ledge structures 812 upon collapsing the accessory so that the foot 804 is against the base 802, the foot can be rotated as indicated by arrow 814 when collapsed.

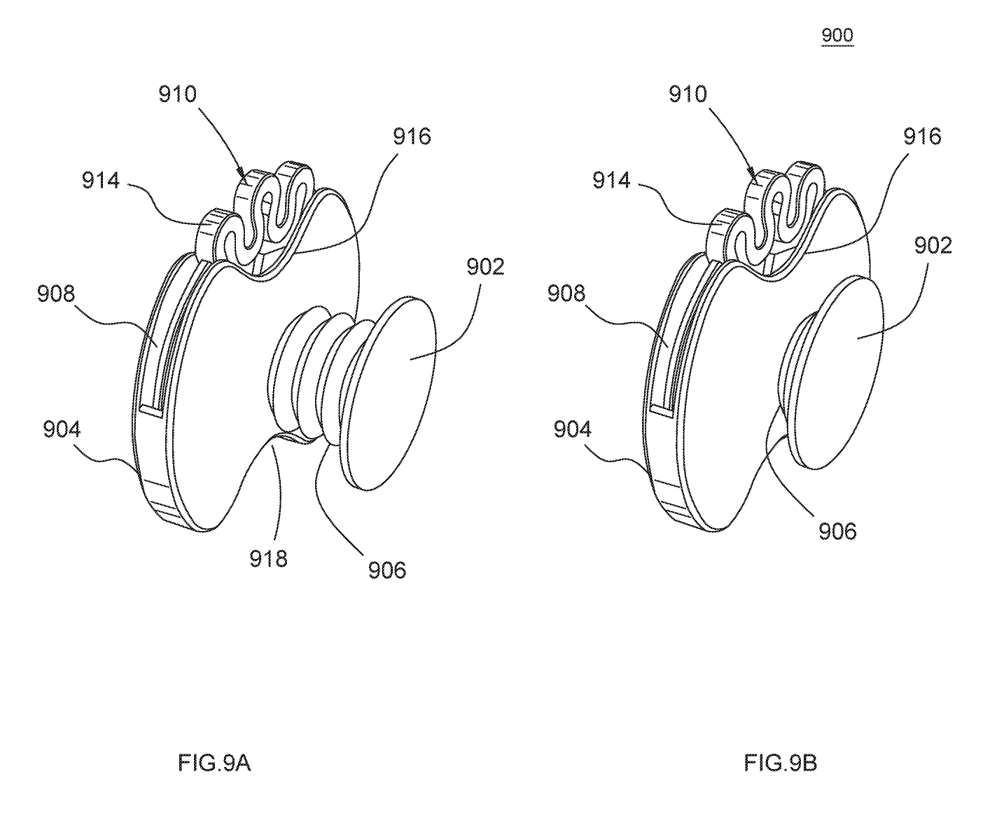

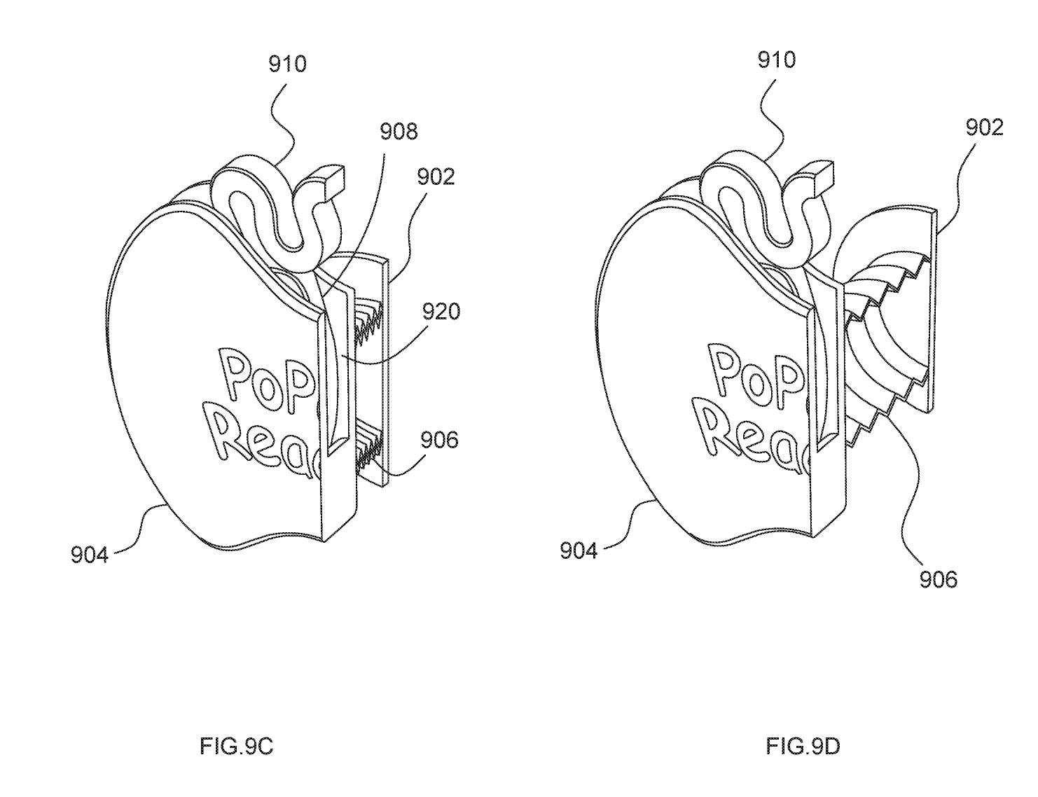

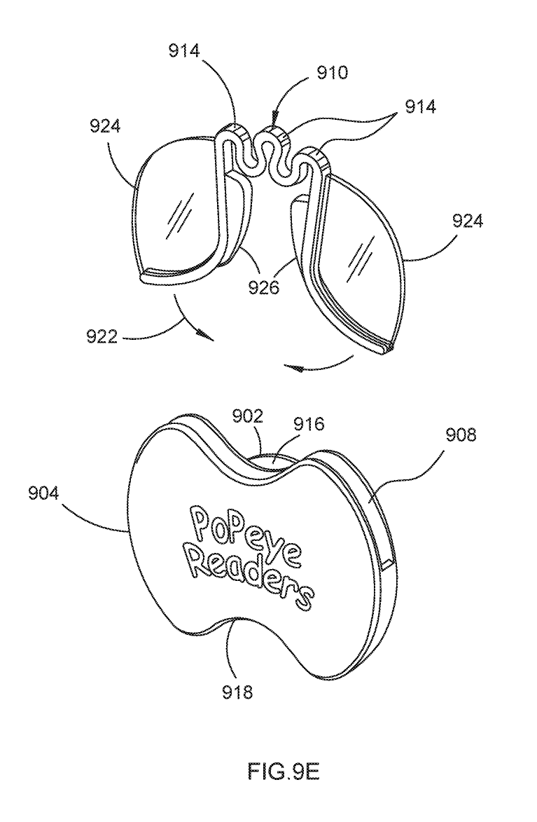

FIGS. 9A-9E show various views of an exemplary holder and stand accessory for use with a mobile device, to hold a pair of folding nose clip-on eyeglasses. FIG. 9A shows a perspective view, generally from the bottom, of an exemplary holder and stand accessory 900 including a pocket 920 for holding folded eyeglasses, in an extended state, in accordance with some embodiments. FIG. 9B show the holder and stand accessory 900 from the same perspective as FIG. 9A in the collapsed state. FIGS. 9C and 9D show the holder and stand accessory 900 from a different perspective, generally from the top, and in cut-away, in the collapsed and expanded states, respectively. FIG. 9E shows the holder and stand accessory 900 in a top perspective view in the collapsed state, and with the eyeglasses outside the accessory being folded to be placed into the pocket in the foot of the accessory.

The accessory 900 includes a base 902 and a foot 904 that are connected together by a collapsible member 906. The foot 904 includes a slot 908 that allows access to a pocket 920 formed inside the foot 904, into which a folded pair of eyeglasses 910 can be kept. The collapsible member 906 shown here is formed a cylindrical format with accordion type walls to allow the collapsible member to be expanded and collapsed. The base 902 is configured to be mounted on or attached to a mobile device. The foot 904 shown here has a “bow tie” plan profile with an upper indentation 916 and a lower indentation 918 in an otherwise generally circular shape. The eyeglasses 910 include a bridge formed of one or more cantilevered lobe segments 914 the provide a range of bending that is greater than a simple straight spring segment, and which also form a handle for the user to hold the eyeglasses 910 when inserting them into the pocket 920 and removing them from the pocket. The indent 916 exposes the bridge of the eyeglasses 910 for easier grasp by the user. The eyeglasses 910, as seen in FIG. 9E, include lenses 924 mounted in structure including the bridge, and are designed to “clip-on” to a user's nose at the bridge of the nose, where nose pads 926 contact the user's nose and the cantilevered lobe segments provide an inward force, causing the nose pads 926 to grip the user's nose and thereby be retained on the user's nose. To fold the eyeglasses 910, the left and right sections with their respective lenses 924 can be moved together, as indicated by arrows 922, so that the eyeglasses 910 can be inserted through the slot 908 into the pocket 920 in the foot 904.

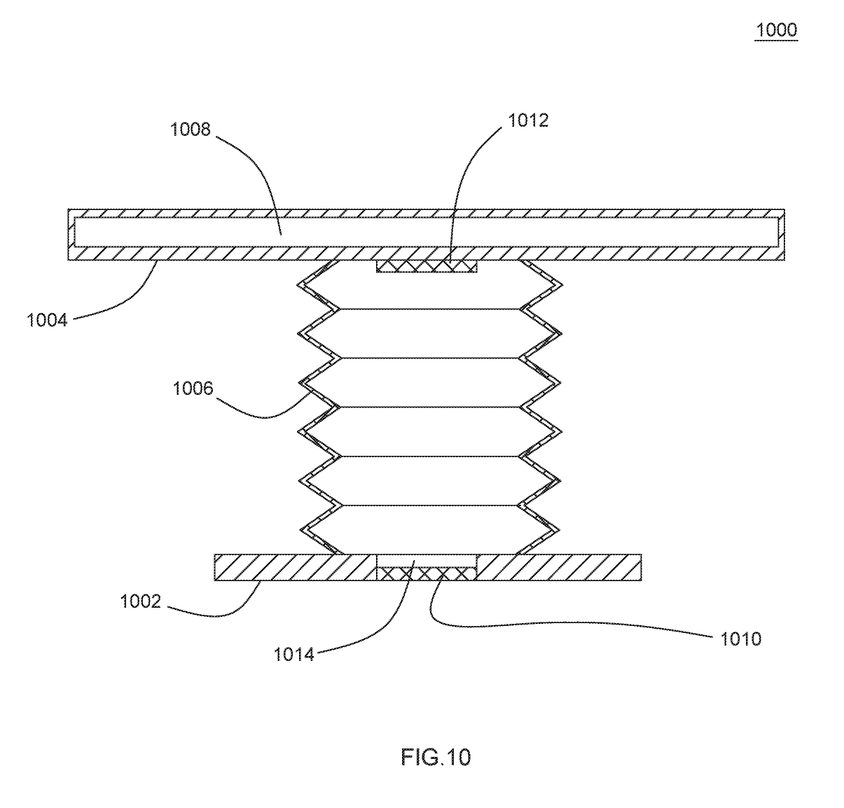

FIG. 10 shows a side elevational cut-away view of a holder and stand accessory 1000 including one or more magnets, in accordance with some embodiments. The accessory 1000 includes a base 1002, a foot 1004, and a collapsible member 1006 connecting the base 1002 and foot 1004 together. The foot 1004 includes a pocket 1008 in which a pair of folding nose clip-on type eyeglasses can be stored and retained. The collapsible member 1006 can be formed in cylindrical form with accordion type segments that allow the collapsible member to be collapsed and expanded. In the expanded state the foot 1004 is moved away from the base 1002 to act as a holder for a person to grasp with their fingers, or as a stand to prop the mobile device up for viewing on a surface. The collapsible member 1006 can be configured to be biased into the expanded state as shown. To retain the foot 1004 in proximity to the base 1002, in the collapsed state, one or more magnets 1010, 1012 can be placed on the base 1002 and foot 1004, respectively, inside the collapsible member 1006. If only one magnet is used, then one of elements 1010, 1012 must be a ferrous metal to attract the magnet. A recess 1014 can be used to provide clearance for one of the magnetic elements and allow space for the collapsible member 1006 in the collapsed state.

It will be appreciated by those skilled in the art that the foot and collapsible member function as a hold, or as a stand, when deployed/extended, and which can be moved to a storage position when not in use . Numerous variations of structures can be implemented that are equivalent. For example, in some embodiments, the base can include the eyeglass pocket, and a stand/hold can be integrated on top of the base. The stand/hold can take the form of a ring, a leg, or other such structures that can be attached at one end to the base, such as by a hinge. Thus, the collapsible member in such embodiments is the stand/hold structure itself, and the foot is equivalent to the terminal end of the structure. Furthermore, in some embodiments, where the eyeglasses are stored in the base, they need not be folded since the base can be made larger as it does not extend and potentially interfere in holding the mobile device. In some embodiments the base can be slightly larger than an unfolded pair of nose clip-on eyeglasses, having a pocket in which the unfolded eyeglasses can be stored/retained.

A holder and stand accessory has been described that facilitates the usage of a mobile device such as, for example, a cellular phone device, and which includes a pocket that is configured to hold and retain a pair of folding or non-folding nose clip-on type eyeglasses. The accessory includes a base and a foot that are connected by a collapsible member, or an equivalent structure, so the that the foot can be extended for use with the collapsible member in an extended state, or moved into adjacent proximity (i.e. against) the base by collapsing the collapsible member. In the extended position, the foot can be used has a hold, with the collapsible member being held between a user's fingers, or as a stand. The foot can have a circular planar profile, or another shape. The accessory provides the benefit of holding a user's eyeglasses in a convenient location, without having to attach a separate glasses case to the mobile device, or carry the glasses in a separate case. In fact the eyeglasses stored in the accessory can be “back up” glasses in the event the user forgets to bring along a more frequently used pair.

What is claimed is:

1. A collapsible holder and stand accessory for a mobile device, comprising:
a base which is adapted to be coupled to a case of the mobile device;
a foot; and
a collapsible member joining the base to the foot that is moveable between a collapsed state and an extended state along a direction of movement;
wherein the foot defines a plane that is perpendicular to the direction of movement of the collapsible member, and includes a pocket formed inside the foot and open and a slot on an edge of the foot.

2. The collapsible holder and stand accessory of claim 1, wherein the base includes a layer of adhesive on a bottom side of the base.

3. The collapsible holder and stand accessory of claim 1, wherein the collapsible member include a spring which urges the foot away from the base.

4. The collapsible holder and stand accessory of claim 1, wherein the collapsible member is a hollow member having an accordion wall configured to allow the collapsible member to collapse and expand.

5. The collapsible holder and stand accessory of claim 4, wherein the collapsible member has a cylindrical form.

6. The collapsible holder and stand accessory of clam 1, wherein the base and foot have corresponding and complementary retaining features configured to retain the foot with the collapsible member in the collapsed state.

7. The collapsible holder and stand accessory of claim 1, wherein the foot includes an indented portion at the slot.

8. The collapsible holder and stand accessory of claim 1, wherein the slot has a slot width which is less than a maximum pocket width.

9. A collapsible holder and stand accessory for a mobile device, comprising:
a base which is adapted to be coupled to a case of the mobile device;
a collapsible member joined to the base at a first end of the collapsible member, wherein the collapsible member is moveable between a collapsed state and an extended state along a direction of movement; and
a foot coupled to the collapsible member at a second end of the collapsible member that is opposite the first end, wherein the foot includes a top and a corresponding bottom defining a pocket between the top and bottom, wherein a portion of the foot is indented from an edge of the foot, and a sidewall is disposed around an outside of the foot between the top and the bottom except for the indented portion, thereby defining a slot opening into the foot at the portion of the foot that is indented.

10. The collapsible holder and stand accessory of claim 9, wherein the base includes a layer of adhesive on a bottom side of the base.

11. The collapsible holder and stand accessory of claim 9, wherein the collapsible member include a spring which urges the foot away from the base.

12. The collapsible holder and stand accessory of claim 9, wherein the collapsible member is a hollow member having an accordion wall configured to allow the collapsible member to collapse and expand.

13. The collapsible holder and stand accessory of claim 9, further comprising a pair of magnetic elements disposed inside the collapsible member, with one of the magnetic elements disposed on the foot and one of the magnetic elements disposed on the base and configured to retain the foot against the base in the collapsed state.

14. The collapsible holder and stand accessory of clam 9, wherein the base and foot have corresponding and complementary retaining features configured to retain the foot with the collapsible member in the collapsed state.

15. The collapsible holder and stand accessory of claim 9, wherein the slot has a slot width which is less than a maximum pocket width.

16. A collapsible holder and stand and eyeglass holder accessory for a mobile device, comprising:
a base defining a plane and configured to be attached at a bottom of the base to the mobile device or a case of the mobile device, a pocket formed in the base that is accessible by a slot opening in a side of the base and which is configured to hold and retain folded eyeglasses;
a collapsible member joined to the base at a first end of the collapsible member, wherein the collapsible member is moveable between a collapsed state and an extended state along a direction of movement the is perpendicular to the plane defined by the base; and
a foot attached to the collapsible member at a second end of the collapsible member.

17. The collapsible holder and stand accessory of claim 16, wherein the base and foot have corresponding and complementary retaining features configured to retain the foot with the collapsible member in the collapsed state.

18. The collapsible holder and stand accessory of claim 16, wherein the collapsible member include a spring which urges the foot away from the base.

19. The collapsible holder and stand accessory of claim 16, wherein the accordion wall is conically shaped.

20. The collapsible holder and stand accessory of claim 16, wherein the foot further includes a pocket configured to hold a second pair of folded eyeglasses.
